(19) United States
(12) Patent Application Publication
(10) Pub. No.: US 2016/0199886 A1
(43) Pub. Date: Jul. 14, 2016

(54) PARALLEL GRIPPING DEVICES IN CLEANING INSTALLATIONS

(71) Applicant: Dürr Ecoclean GmbH, Filderstadt (DE)

(72) Inventor: Oliver Schmidt-Schwan, Alsdorf (DE)

(21) Appl. No.: 15/063,045

(22) Filed: Mar. 7, 2016

Related U.S. Application Data
(63) Continuation-in-part of application No. PCT/EP2014/072468, filed on Oct. 20, 2014.

(30) Foreign Application Priority Data
Nov. 4, 2013 (DE) 10 2013 222 314.5

(51) Int. Cl. B08B 3/04; B25B 5/02; B25J 15/02; B25B 5/06

(52) U.S. Cl. CPC B08B 3/04; B25B 5/061; B25B 5/02; B25J 15/026

(57) ABSTRACT

Parallel gripping devices in cleaning installations are disclosed. A disclosed gripping device includes a first parallel gripper jaw support including a first gear rack, and a second parallel gripper jaw support including a second gear rack. The disclosed gripping device also includes a coupling gear operatively coupled to the first and second gear racks, the coupling gear to couple a motion of the first and second gear racks in a linear direction, where a rotational movement direction of the coupling gear varies whether the first and the second gear racks move towards or away from one another. The disclosed gripping device also includes an actuator to cause at least one of the first or second parallel gripper jaw supports to move along the linear direction.

### RELATED APPLICATIONS

This patent arises as a continuation-in-part of International Patent Application No. PCT/EP2014/072468, which was filed on Oct. 20, 2014, and which claims priority to German Patent Application No. 10 2013 222 314, which was filed on Nov. 4, 2013. The foregoing International Patent Application and German Patent Application are hereby incorporated herein by reference in their entireties.

### FIELD OF THE DISCLOSURE

This disclosure relates generally to workpiece cleaning, and, more particularly, to parallel gripping devices in cleaning installations.

### BACKGROUND

Parallel grippers have a gripper body with a first gripper jaw support that is received and guided by the gripper body to be movable in a linear movement direction, and also include a second gripper jaw support that is received and guided by the gripper body to be movable in the linear movement direction. Some parallel grippers also have a drive device to move the first gripper jaw support and the second gripper jaw support in a linear manner between an opened position and a closed position.

### BRIEF DESCRIPTION OF THE DRAWINGS

FIG. 1 shows a handling robot having a parallel gripper in which the examples disclosed herein may be implemented as well as a workpiece that has been received between two gripper jaws of the parallel gripper.

FIG. 2 shows a perspective partial view of the parallel gripper of FIG. 1 with the gripper jaws removed for clarity.

FIGS. 3a and 3b show a pneumatic circuit diagram of the parallel gripper of FIGS. 1 and 2.

FIG. 4 shows a perspective partial section view of the parallel gripper, along the line IV-IV of FIG. 2.

FIG. 5 shows a partial section view of the parallel gripper, along the line V-V of FIG. 2.

The figures are not to scale. Instead, to clarify multiple layers and regions, the thickness of the layers may be enlarged in the drawings. Wherever possible, the same reference numbers will be used throughout the drawing(s) and accompanying written description to refer to the same or like parts. As used in this patent, stating that any part is in any way positioned on (e.g., positioned on, located on, disposed on, or formed on, etc.) another part, means that the referenced part is either in contact with the other part, or that the referenced part is above the other part with one or more intermediate part(s) located therebetween. Stating that any part is in contact with another part means that there is no intermediate part between the two parts.

### DETAILED DESCRIPTION

Parallel gripping devices in cleaning installations are disclosed. The examples disclosed herein relate to parallel grippers having a gripper body with a first gripper jaw support, which is received and guided on the gripper body to be movable in a linear movement direction, a second gripper jaw support, which is received and guided on the gripper body to be movable in the linear movement direction, and a drive device to move the first gripper jaw support and the second gripper jaw support in a linear manner between an opened position and a closed position.

A known parallel gripper is shown in EP 1 245 346 B1, which is hereby incorporated by reference. This known parallel gripper has a gripper body as well as a first and a second gripper jaw support to receive gripper jaws. The first gripper jaw support and the second gripper jaw support are guided on the gripper body to be movable in a linear movement direction. The gripper jaw supports here may be moved towards and away between an opened position and a closed position. To move the gripper jaw supports, the parallel gripper includes a drive device with a first and a second drive device, both of which include an actuator in the form of a piston, which is impinged with fluid pressure, and a stator that receives a counterforce introduced into the respective piston. The pistons of the first and of the second drive device are guided in the gripper body to be movable in a linear manner in a direction that is substantially perpendicular to the movement direction of the gripper jaw supports and are motionally coupled/linked via a deflection gear to the first and the second gripper jaw supports.

It is an object of the examples disclosed herein to enable a parallel gripper with a compact construction for picking up high loads in particular, such as a handling robot in which the parallel gripper, the gripper body and/or the gripper jaw supports may be accommodated with the drive device in a relatively small space.

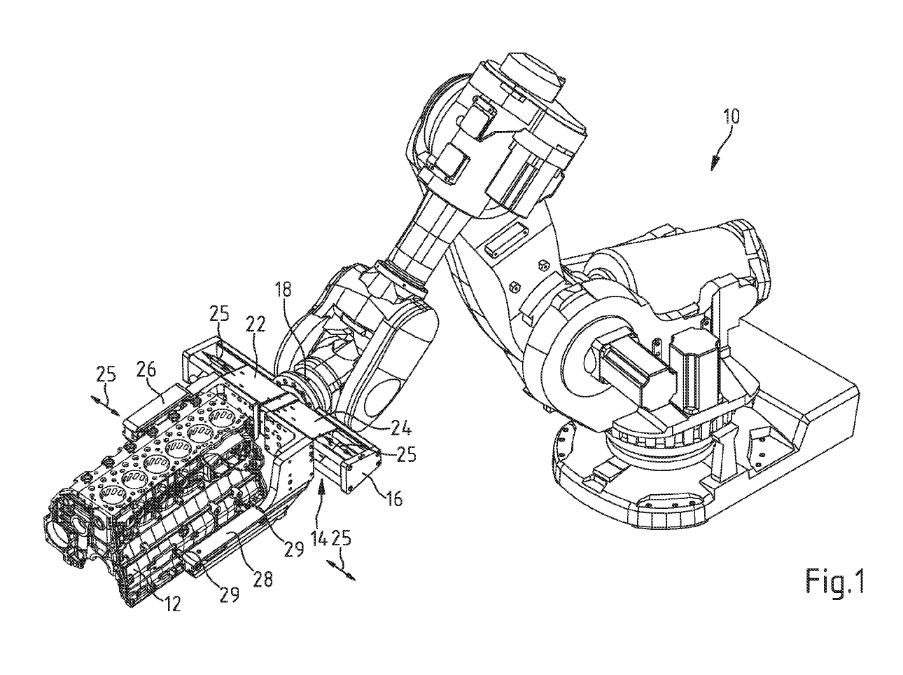

Turning to FIG. 1, a handling robot 10 of the illustrated example is depicted as picking up workpieces 12 in a cleaning installation. The example handling robot 10 is also suitable for disposal operations within a process chamber of the cleaning installation in which the workpieces 12 that have been received on the handling robot 10 are cleaned with a fluid medium, which is a liquid in this example (e.g., water). In this example, the fluid medium is provided with cleaning additives and made available to immersion baths or spraying nozzles, or preferably, using hot steam that flows out of appropriate nozzles, for example.

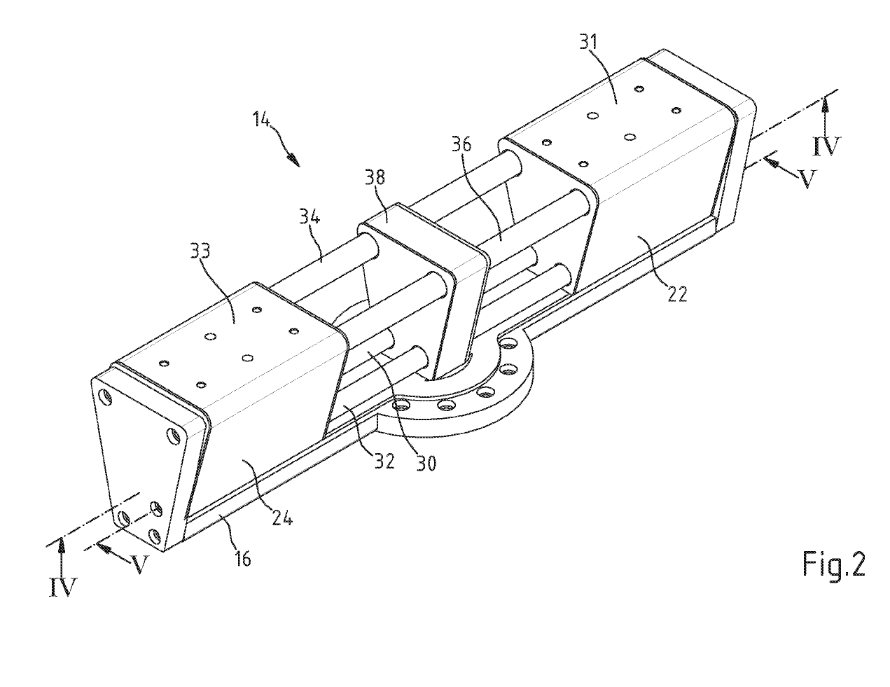

To pick up the workpieces 12, an example parallel gripper 14 is connected and/or coupled to the handling robot 10. The example parallel gripper 14 includes a gripper body 16, which is secured on a tool interface 18 of the handling robot 10. The parallel gripper 14 of the illustrated example also includes both a first gripper jaw support 22 and a second gripper jaw support 24. In this example, the gripper jaw supports 22, 24 are guided by a guide device on the gripper body 16 to be movable in a linear manner along a direction generally indicated by double arrows 25. To handle a workpiece 12, which is an engine block in this example, the gripper jaw supports 22, 24 have two gripper jaws 26, 28, respectively. The gripper jaws 26, 28 of the illustrated example are both secured on interfaces 31, 33, respectively, (See FIG. 2) of the gripper jaw supports 22, 24 that couple the gripper jaws 26, 28 to the gripper jaw supports 22, 24, for example. In some examples, the gripper jaws 26, 28 are, preferably, at least partially composed of hard-anodized aluminum or hardened stainless steel. In this example, gripper jaws 26, 28, for engaging in bores in the workpiece 12 have bolt-shaped support elements 30 that are adapted to the workpiece 12.

To pick up and release a workpiece, the gripper jaws 26, 28 of the parallel gripper 14 may be displaced between an opened and a closed position. To move the gripper jaws 26, 28, the parallel gripper 14, which acts as a drive device in this example, contains a linear drive that displaces the gripper jaw supports 22, 24, is supported on the gripper body 16 and includes a compressed air system.

FIG. 2 shows a perspective partial view of the example parallel gripper 14 with the two gripper jaws 26, 28 removed for clarity. In this example, the guide device of the gripper jaw supports 22, 24 includes four guide rods 30, 32, 34, 36 that are mutually parallel, for example, and penetrate through a gear housing 38 that is fixedly coupled to the gripper body 16. In this example, the gear housing 38 includes a synchronizing gear, which mutually couples and/or links movement of the first gripper jaw support 22 to movement of the second gripper jaw support 24.

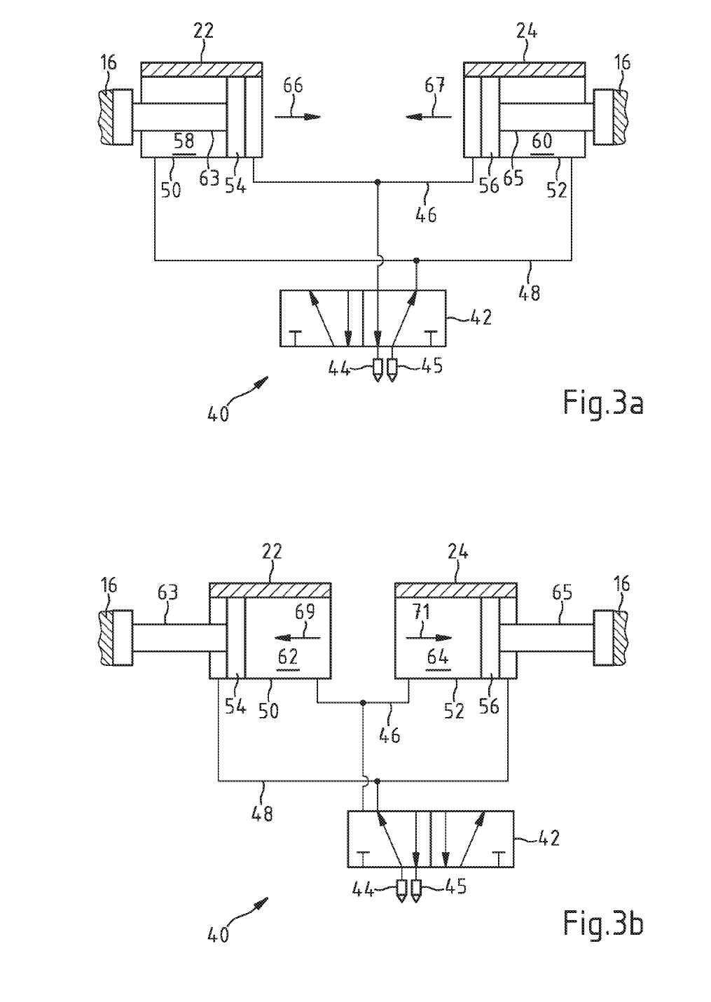

FIG. 3a illustrates the compressed air system 40 of the linear drive in a switched state corresponding to the opened position of the gripper jaw supports 22, 24. In FIG. 3b, the compressed air system 40 of the linear drive is, in contrast to FIG. 3a, shown in a switched position corresponding to the closed position of the gripper jaw supports 22, 24.

In the example of FIGS. 3a and 3b, the compressed air system 40 of the linear drive includes a 5/2-way valve 42, a connector 44 to supply compressed air, and a connector 45, from which compressed air may be released. The compressed air system 40 of the illustrated example has a first compressed air line 46 and a second compressed air line 48, both of which are impinged with compressed air by way of the 5/2-way valve 42. The compressed air lines 46, 48 are coupled to a first cylinder 50 having compressed air and to a second cylinder 52, respectively. In this example, the cylinders 50, 52 are fixedly coupled to the gripper jaw supports 22, 24. The cylinders 50, 52 of the illustrated example are disposed so as to be positionally fixed in relation to the gripper jaw supports 22, 24 and, thus, both act as a linear drive to move the gripper jaw support 22, 24. In this example, both of the cylinders 50, 52 contain a dual-action piston 54, 56, respectively, each of which subdivides cylinder space of the cylinders 50, 52 into respective first operating chambers 58, 60 and second operating chambers 62, 64. In this example, the first operating chamber 58 of the cylinder 50 is in fluid communication with the first operating chamber 60 of the cylinder 52 via the compressed air line 48. The second operating chamber 62 of the cylinder 50 and the second operating chamber 64 of the cylinder 52 are interconnected and/or fluidly coupled by the compressed air line 46, for example. In this example, each of the pistons 54, 56 is coupled to piston rods 63, 65, respectively, which protrude into the respective cylinders 50, 52 and are secured on the gripper body 16. Each of the piston rods 63, 65, which have the piston received thereon, thus, acts as a stator of the linear drive.

In the switched position shown in the illustrated example of FIG. 3a, the 5/2-way valve 42 is configured and/or set such that the compressed air that is provided at the connector 44 via the compressed air line 48 moves the cylinders 50, 52 in a direction generally indicated by arrows 66, 67 to a closed position. In the switched position shown in FIG. 3b, the 5/2-way valve 42, via the compressed air line 48, causes the compressed air that is provided to the connector 44 to displace the cylinders 50, 52 in a direction generally indicated by arrows 69, 71 to an open position, for example.

In some examples, it should be noted that to adjust the gripper jaw supports 22, 24 of the parallel gripper 14, a drive device includes a linear drive, which is operated by hydraulic pressure. Additionally or alternatively, in some examples, the drive device includes a linear drive that contains an electric servomotor such as a linear motor, for example, which has a stator that is supported on the gripper body and a rotor, which is coupled to a gripper jaw support 22, 24 and movable in a linear manner to act as an actuator, for example.

Moreover, in some examples, the parallel gripper 14 may contain a gripping-force safeguard to enable (e.g., guarantee) a minimum compression force of the gripper jaws acting on a workpiece, which is received in the parallel gripper 14, is maintained (e.g., ensured) in the event of a sudden failure of the linear drive, which may be caused by a pressure loss in the compressed air system, for example.

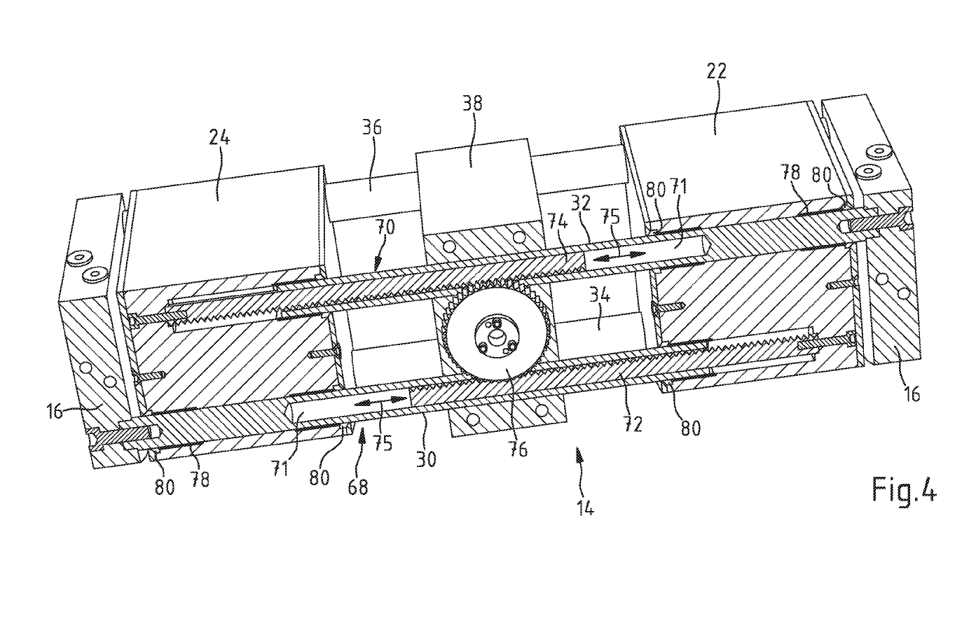

FIG. 4 shows a perspective partial section view of the example parallel gripper 14, along the line IV-IV of FIG. 2. The guide rods 30, 32 of the illustrated example each have portions 68, 70, respectively, each of which is configured as a hollow body, for example. The portion that is configured as a hollow body 68, 70 includes a void 71, in which a gear element shown as a first rack 72 and in which an additional gear element shown as a second rack 74, for example, is guided to be movable in a linear manner along a direction generally indicated by a double arrow 75.

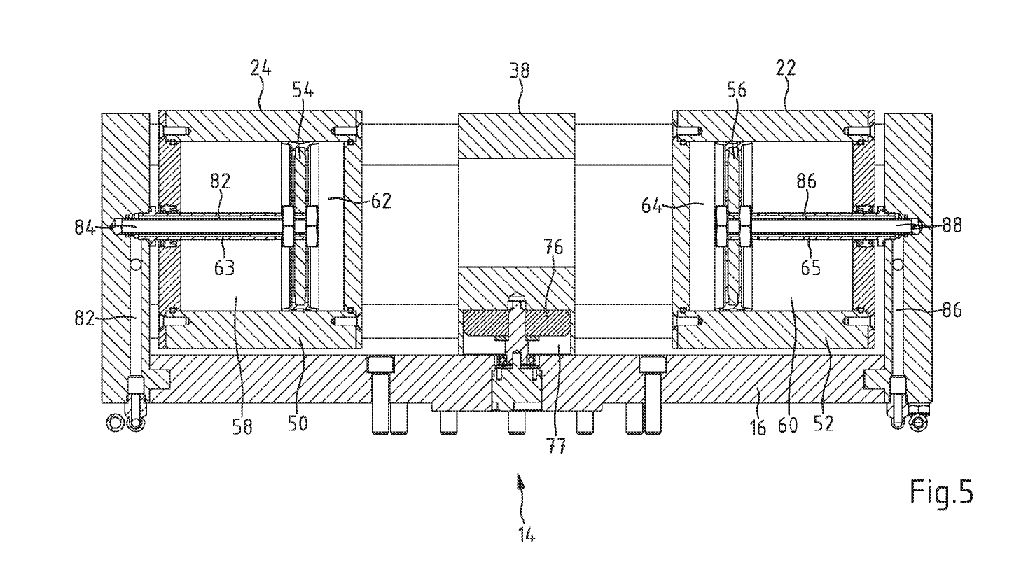

The guide rods 30, 32 of the illustrated example are coupled and/or connected to the gripper body 16. In this example, the rack 72 is secured in the gripper jaw support 22. Similarly, the rack 74 is fixedly coupled to the gripper jaw support 24. The gear housing 38 surrounds a gear space 77 (see FIG. 5), in which a linking gear wheel 76 that acts as a linking element is rotatably mounted in a bearing and at least partially passes though through an opening in the first guide rod 30 and an opening in the second guide rod 32 to engage the first rack 72 and to the second rack 74, respectively, for example.

In some examples, the bearing of the linking gear wheel 76 is, preferably, configured as a hybrid grooved ball bearing and contains raceways at least partially composed of stainless steel and balls (e.g., ball bearings) at least partially composed of ceramics, such as Si₃N₄, for example. In some examples, the cage of the roller bearing is, favorably, also at least partially composed of stainless steel. In other examples, however, the cage may also be manufactured from PEEK material. Additionally or alternatively, the grooved roller bearing of the illustrated example described above may be operated in a lubricant-free manner.

In some examples, a gear space (e.g., a cavity) 77 is substantially sealed and/or hermetically sealed (e.g., sealed in a fluid-tight manner) by the gear housing 38. As a result, when the parallel gripper is operated in a cleaning installation to reduce (e.g., avoid or eliminate) lubricants washing out of the gear space 77 by the cleaning media employed in the aforementioned cleaning installation. Additionally or alternatively, intrusion of cleaning media into the gear space 77 may be reduced, substantially reduced and/or eliminated altogether in a particularly efficient manner when the gear space is impinged with sealing air, for example.

The gripper jaw supports 22, 24 of the illustrated example are held onto each of the guide rods 30, 32, 34, 36 via a respective linear bearing, each of which is configured as a friction bearing and has a bearing sleeve that is secured in the gripper jaw support 22 or 24, respectively, for example. The linear bearings of the guide rods 30, 32, 34, 36 in the gripper jaw support 22 are lubricant-free linear bearings, for example. In this example, the lubricant-free linear bearings on a side that faces the gripper body 16 and on a side that faces the gear body 36 are protected by a respective wiper element 80 against contamination and cleaning liquid. Likewise, in this example, the same use of wiper elements 80 also correspondingly applies to the gripper jaw support 24 as well.

FIG. 5 is a partial section view of the example parallel gripper 14 along the line V-V of FIG. 2. In the illustrated example of FIG. 5, the piston rod 63, which is coupled to the piston 54, includes a fluid line 82, which is used for supplying and discharging compressed air, that fluidly communicates with the first operating chamber 58 of the cylinder 50 and with the compressed air line 48 described above in connection with FIGS. 3a and 3b. Moreover, in this example, a fluid line 84, which is coupled to the compressed air line 46 and fluidly communicates with the second operating chamber 62 of the cylinder 50, is also integrated into the piston rod 63.

Accordingly, in this example, the piston rod 65, which is coupled to the piston 56, includes a fluid line 86 to supply and discharge compressed air. The example fluid line 86 fluidly communicates with the first operating chamber 60 of the compressed air cylinder 52 and with the compressed air line 48 described above in connection with FIGS. 3a and 3b. Moreover, a fluid line 88 of the illustrated example, which is coupled to the compressed air line 46 and in fluid communication with the second operating chamber 64 of the compressed air cylinder 56, is also integrated into the piston rod 65, for example.

In some examples, the following preferred features may be used. In particular, a parallel gripper 14 includes a gripper body 16 and a first gripper jaw support 22, which is received and guided in a linearly movable manner on the gripper body 16 to be movable in a linear movement direction, and a second gripper jaw support 24, which is received and guided in a linearly movable manner on the gripper body 16 to be movable in the linear movement direction. The example parallel gripper 14 includes a drive device to move the first gripper jaw support 22 and the second gripper jaw support 24 in a linear manner between an opened and closed position. In this example, the drive device also includes a linear drive with at least one stator 63, 65 that is secured on the gripper body 16 and has at least one actuator 50, 52, which is movable in the linear movement direction relative to the stator 63, 65 and motionally coupled/linked to the first gripper jaw support 22 and the second gripper jaw support 24.

It is an object of the examples disclosed herein to provide a parallel gripper with a compact construction for picking up high loads such as, in particular, a handling robot, in which a parallel gripper, a gripper body and gripper jaw supports may be accommodated along with the drive device in a relatively small space and/or volume.

This object may be achieved by a parallel gripper by drive device that has a linear drive having at least one stator that is secured on the gripper body and having at least one actuator, which is movable relative to the stator in the linear movement direction and motionally coupled/linked to the first gripper jaw support and the second gripper jaw support, for example.

In some examples, each of the first and the second gripper jaw supports are configured to receive gripper jaws. These gripper jaws are designed and/or configured such that they may be brought to bear on a workpiece to be picked up and/or may be brought to engage with openings and/or clearances in a workpiece and/or protrusions and/or connector elements on a workpiece.

In some examples, the at least one actuator in the parallel gripper is, preferably, configured as a cylinder, is impinged with a fluid medium, is fixedly coupled to the first gripper jaw support and is, preferably, integrated in the gripper jaw support, for example. In some examples, the at least one stator is, advantageously, designed and/or configured as a piston rod that protrudes into the cylinder and has a piston that is coupled to the piston rod.

In some examples, the cylinder, preferably, has a cylinder space, which is subdivided by the piston into a first operating chamber and a second operating chamber. A first fluid line, which communicates with the first operating chamber, and a second fluid line, which communicates with the second operating chamber, may be integrated into the piston rod, for example.

In some examples, the parallel gripper may also include an additional actuator as well as an additional stator. The additional actuator in the parallel gripper is, likewise, preferably configured as a cylinder, which is impinged with a fluid medium, fixedly coupled to the first gripper jaw support and, preferably, integrated in the gripper jaw support. The additional stator, in turn, is configured as a piston rod, which protrudes into the cylinder with a piston that is coupled to the piston rod, for example. This cylinder may, preferably, also include a cylinder space, by which the piston subdivides into a first operating chamber and a second operating chamber. In this example, a first fluid line that is in fluid communication with the first operating chamber, and a second fluid line that is in fluid communication with the second operating chamber may be, likewise, integrated into the piston rod.

In some examples, the parallel gripper may have a guide device to guide the first gripper jaw support and the second gripper jaw support to be movable in a linear manner. The guide device may include a first guide rod that is secured on the gripper body and also guides the first gripper jaw support, and an additional guide rod that is secured on the gripper body and guides the second gripper jaw support while being substantially parallel to the first guide rod, for example.

In some examples, it is advantageous for the first gripper jaw support to be held onto the first guide rod via a linear bearing. This linear bearing here may be preferably configured as a friction bearing, which has a bearing sleeve that is secured in the first gripper jaw support. In some examples, the parallel gripper may also have at least one wiper that protects the linear bearing. In some examples, it is also advantageous for the second gripper jaw support to be held on the further guide rod in a linear bearing.

In some examples, the linear bearing may, in particular, be configured as a friction bearing, which has a bearing sleeve that is secured in the first gripper jaw support, for example. In such examples as well, at least one wiper to substantially isolate and/or protect the linear bearing is, preferably, provided.

In some examples, when the first guide rod and the additional guide rod are at least partially configured as a hollow body with a void, it is possible for a synchronizing gear that links/couples the movement of the first gripper jaw support to the second gripper jaw support to be provided. The synchronizing gear may have a first gear element, which is secured on the first gripper jaw support and guided to be movable in a linear manner within the void of the first guide rod, and an additional gear element, which is secured on the second gripper jaw support and guided to be movable in a linear manner within the void of the second guide rod.

It is advantageous in this example for the first gear element and the additional gear element to be motionally linked/coupled via a linking element that is movably mounted on/to the gripper body. In some examples, the first gear element and the additional gear element may, in particular, include a rack and/or a rack portion, where the linking element that is mounted on the gripper body is configured as a linking gear wheel that engages the rack portion of the first gear element via an opening in the first guide rod and to the rack portion of the additional gear element via an opening in the additional guide rod. To avoid lubricant washing out of the synchronizing gear during operation of the parallel gearing in cleaning installations, for example, a gear, which is hermetically sealed and/or impinged with sealing air, is secured to the gripper body, and receives the linking gear wheel is, preferably, positioned in the parallel gripper.

A parallel gripper according to the examples disclosed herein may also be employed in surroundings and/or environments such as a cleaning installation, for example, in which a parallel gripper is in contact with a wide variety of chemicals and high-pressure water jets, and in which high cleaning temperatures of 60° C., for example, or in excess thereof, may be prevalent.

The examples disclosed herein may also apply to a handling robot used in a cleaning installation. In such examples, the robot may be used to pick up and hold workpieces using a parallel gripper, as described above. Moreover, the examples disclosed herein also extend to a cleaning installation for cleaning workpieces, which use liquid and/or vaporous cleaning fluid in a cleaning chamber that includes at least one handling robot having a parallel gripper as stated above to handle workpieces in the cleaning chamber.

An example parallel gripper includes a gripper body, a first gripper jaw support that is received and guided on the gripper body to be movable in a linear movement direction, and a second gripper jaw support that is received and guided on the gripper body to be movable in the linear movement direction. The example parallel gripper also includes a drive device to move the first gripper jaw support and the second gripper jaw support in a linear manner between respective opened and closed positions, where the drive device has a linear drive including at least one stator that is secured on the gripper body and having at least one actuator that in relation to the stator is movable in the linear movement direction and is motionally coupled to the first and second gripper jaw supports. The example parallel gripper also includes a guide device to guide the first gripper jaw support and the second gripper jaw support to be movable in a linear manner, where the guide device has a first guide rod that is secured on the gripper body and guides the first gripper jaw support, where the guide device has a further guide rod that is secured on the gripper body, guides the second gripper jaw support and is substantially parallel to the first guide rod, where the first guide rod and the further guide rod are at least partially configured as a hollow body having a void. The example parallel gripper also includes a synchronizing gear that couples the movement of the first gripper jaw support and the second gripper jaw support, where the synchronizing gear has a first gear element that is secured on the first gripper jaw support and guided to be movable in a linear manner in the void of the first guide rod, and a further gear element that is secured on the second gripper jaw support and guided to be movable in a linear manner in the void of the second guide rod.

In some examples, the first gear element and the further gear element are motionally coupled via a linking element that is movably mounted on the gripper body. In some examples, the first gear element and the further gear element each comprise a rack, and the linking element that is mounted on the gripper body is configured as a linking gear wheel that engages, via an opening in the first guide rod, to the rack of the first gear element and, via an opening in the further guide rod, to the rack of the further gear element.

In some examples, the example parallel gripper also includes a housing that is at least one of hermetically sealed or impinged with sealing air, is secured on the gripper body and receives the linking gear wheel. In some examples, the at least one actuator is configured as a cylinder that is impinged with a fluid medium and fixedly coupled to the first gripper jaw support. In some examples, the at least one actuator is integral with the gripper jaw support, and the at least one stator is configured as a piston rod that protrudes into the cylinder, the at least one stator having a piston that is coupled to the piston rod.

In some examples, the cylinder has a cylinder space that is subdivided into a first operating chamber and into a second operating chamber by the piston. In some examples, a first fluid line that communicates with the first operating chamber, and a second fluid line that communicates with the second operating chamber are integral with the piston rod. In some examples, the example parallel gripper also includes a further actuator and a further stator, where the further actuator is configured as a cylinder that is impinged with a fluid medium and fixedly coupled to the second gripper jaw support. In some examples, the further actuator is integral with the gripper jaw support, and the further stator is configured as a piston rod that protrudes into the cylinder, the further stator having a piston that is connected to the piston rod.

In some examples, the cylinder has a cylinder space that is subdivided into a first operating chamber and a second operating chamber by the piston. In some examples, a first fluid line that communicates with the first operating chamber, and a second fluid line that communicates with the second operating chamber are integrated into the piston rod. In some examples, the first gripper jaw support is held on the first guide rod in a linear bearing.

In some examples, the linear bearing is configured as a friction bearing that has a bearing sleeve secured in the first gripper jaw support or that at least one wiper that protects the linear bearing is provided. In some examples, the second gripper jaw support is held on the further guide rod in a linear bearing. In some examples, a handling robot for a cleaning installation having a parallel gripper that is configured according to the examples disclosed herein. In some examples, an example cleaning installation for cleaning workpieces uses one or more of a liquid or vaporous cleaning fluid in a cleaning chamber, the cleaning installation having a handling robot as defined in the examples disclosed herein.

An example gripping device includes a first parallel gripper jaw support including a first gear rack, and a second parallel gripper jaw support including a second gear rack. The example gripping device includes a coupling gear operatively coupled to the first and second gear racks, where the coupling gear is to couple a motion of the first and second gear racks in a linear direction, where a rotational movement direction of the coupling gear varies whether the first and the second gear racks move towards or away from one another. The example gripping device also includes an actuator to cause at least one of the first or second parallel gripper jaw supports to move along the linear direction.

In some examples, the example gripping device also includes at least one guide rod to guide a motion of the first gear rack or the second gear rack. In some examples, the at least one guide rod defines an opening in which at least a portion of the coupling gear passes through to engage a respective one of the first or the second gear racks. In some examples, the example gripping device includes a gasket to seal the at least one guide rod to at least one of the first or the second parallel gripper jaw supports.

In some examples, the example gripping device also includes a gripper body, where the gripper body causes at least one of the first or second parallel gripper jaw supports to move based on a movement of the actuator. In some examples, the example gripping device also includes a gear housing, wherein the coupling gear is disposed within a substantially sealed cavity of the gear housing.

In some examples, the example gripping device also includes a pressurized fluid source to provide pressurized fluid to the substantially sealed cavity. In some examples, the first parallel gripper jaw support is coupled to the first gear rack, and the second parallel gripper jaw support is coupled to the second gear rack. In some examples, the first parallel gripper jaw support defines the first gear rack, and the second parallel gripper jaw support defines the second gear rack.

This patent arises as a continuation-in-part of International Patent Application No. PCT/EP2014/072468, which was filed on Oct. 20, 2014, and which claims priority to German Patent Application No. 10 2013 222 314, which was filed on Nov. 4, 2013. The foregoing International Patent Application and German Patent Application are hereby incorporated herein by reference in their entireties.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A parallel gripper comprising:
a gripper body;
a first gripper jaw support that is received and guided on the gripper body to be movable in a linear movement direction;
a second gripper jaw support that is received and guided on the gripper body to be movable in the linear movement direction;
a drive device to move the first gripper jaw support and the second gripper jaw support in a linear manner between respective opened and closed positions, wherein the drive device has a linear drive including at least one stator that is secured on the gripper body and having at least one actuator that in relation to the stator is movable in the linear movement direction and is motionally coupled to the first and second gripper jaw supports;
a guide device to guide the first gripper jaw support and the second gripper jaw support to be movable in a linear manner, the guide device having a first guide rod that is secured on the gripper body and guides the first gripper jaw support, the guide device having a further guide rod that is secured on the gripper body, guides the second gripper jaw support and is substantially parallel to the first guide rod, wherein the first guide rod and the further guide rod are at least partially configured as a hollow body having a void; and
a synchronizing gear that couples the movement of the first gripper jaw support and the second gripper jaw support, the synchronizing gear having a first gear element that is secured on the first gripper jaw support and guided to be movable in a linear manner in the void of the first guide rod, and a further gear element that is secured on the second gripper jaw support and guided to be movable in a linear manner in the void of the second guide rod.

2. The parallel gripper as defined in claim 1, wherein the first gear element and the further gear element are motionally coupled via a linking element that is movably mounted on the gripper body.

3. The parallel gripper as defined in claim 2, wherein the first gear element and the further gear element each comprise a rack, and the linking element that is mounted on the gripper body is configured as a linking gear wheel that engages, via an opening in the first guide rod, to the rack of the first gear element and, via an opening in the further guide rod, to the rack of the further gear element.

4. The parallel gripper as defined in claim 3, further including a housing that is at least one of hermetically sealed or impinged with sealing air, is secured on the gripper body and receives the linking gear wheel.

5. The parallel gripper as defined in claim 1, wherein the at least one actuator is configured as a cylinder that is impinged with a fluid medium and fixedly coupled to the first gripper jaw support.

6. The parallel gripper as defined in claim 5, wherein the at least one actuator is integral with the gripper jaw support, and the at least one stator is configured as a piston rod that protrudes into the cylinder, the at least one stator having a piston that is coupled to the piston rod.

7. The parallel gripper as defined in claim 6, wherein the cylinder has a cylinder space that is subdivided into a first operating chamber and into a second operating chamber by the piston.

8. The parallel gripper as defined in claim 7, wherein a first fluid line that communicates with the first operating chamber, and a second fluid line that communicates with the second operating chamber are integral with the piston rod.

9. The parallel gripper as defined in claim 7, further including a further actuator and a further stator, wherein the further actuator is configured as a cylinder that is impinged with a fluid medium and fixedly coupled to the second gripper jaw support.

10. The parallel gripper as defined in claim 9, wherein the further actuator is integral with the gripper jaw support, and the further stator is configured as a piston rod that protrudes into the cylinder, the further stator having a piston that is connected to the piston rod.

11. The parallel gripper as defined in claim 10, wherein the cylinder has a cylinder space that is subdivided into a first operating chamber and a second operating chamber by the piston.

12. The parallel gripper as defined in claim 11, wherein a first fluid line that communicates with the first operating chamber, and a second fluid line that communicates with the second operating chamber are integrated into the piston rod.

13. The parallel gripper as defined in claim 1, wherein the first gripper jaw support is held on the first guide rod in a linear bearing.

14. The parallel gripper as defined in claim 13, wherein the linear bearing is configured as a friction bearing that has a bearing sleeve secured in the first gripper jaw support or that at least one wiper that protects the linear bearing is provided.

15. The parallel gripper as defined in claim 1, wherein the second gripper jaw support is held on the further guide rod in a linear bearing.

16. The parallel gripper as defined in claim 15, wherein the linear bearing is configured as a friction bearing that has a bearing sleeve secured in the first gripper jaw support.

17. A handling robot for a cleaning installation, having a parallel gripper which is configured as defined in one of claims 1 to 16.

18. A cleaning installation for cleaning workpieces using one or more of a liquid or vaporous cleaning fluid in a cleaning chamber, the cleaning installation having a handling robot as defined in claim 17 that is disposed in a cleaning chamber.

19. A gripping device comprising:
a first parallel gripper jaw support including a first gear rack;
a second parallel gripper jaw support including a second gear rack;
a coupling gear operatively coupled to the first and second gear racks, the coupling gear to couple a motion of the first and second gear racks in a linear direction, wherein a rotational movement direction of the coupling gear varies whether the first and the second gear racks move towards or away from one another; and
an actuator to cause at least one of the first or second parallel gripper jaw supports to move along the linear direction.

20. A gripping device as defined in claim 19, further including at least one guide rod to guide a motion of the first gear rack or the second gear rack.

21. A gripping device as defined in claim 20, wherein the at least one guide rod defines an opening in which at least a portion of the coupling gear passes through to engage a respective one of the first or the second gear racks.

22. A gripping device as defined in claim 20, further including a gasket to seal the at least one guide rod to at least one of the first or the second parallel gripper jaw supports.

23. A gripping device as defined in claim 19, further including a gripper body, wherein the gripper body causes at least one of the first or second parallel gripper jaw supports to move based on a movement of the actuator.

24. A gripping device as defined in claim 19, further including a gear housing, wherein the coupling gear is disposed within a substantially sealed cavity of the gear housing.

25. A gripping device as defined in claim 24, further including a pressurized fluid source to provide pressurized fluid to the substantially sealed cavity.

26. A gripping device as defined in claim 19, wherein the first parallel gripper jaw support is coupled to the first gear rack, and the second parallel gripper jaw support is coupled to the second gear rack.

27. A gripping device as defined in claim 19, wherein the first parallel gripper jaw support defines the first gear rack, and the second parallel gripper jaw support defines the second gear rack.
